(19) United States
(12) Patent Application Publication
(10) Pub. No.: US 2014/0084208 A1
(43) Pub. Date: Mar. 27, 2014

(54) SOLVENT, PROCESS FOR PROVIDING AN ABSORPTION LIQUID, AND USE OF THE SOLVENT

(71) Applicants: Björn Fischer, Frankfurt a.M. (DE); Ralph Joh, Seligenstadt (DE); Rüdiger Schneider, Eppstein (DE)

(72) Inventors: Björn Fischer, Frankfurt a.M. (DE); Ralph Joh, Seligenstadt (DE); Rüdiger Schneider, Eppstein (DE)

(21) Appl. No.: 13/981,392

(22) PCT Filed: Jan. 12, 2012
(86) PCT No.: PCT/EP12/50399

§ 371 Date: Jul. 24, 2013

(30) Foreign Application Priority Data
Jan. 31, 2011 (EP) 11152688.5

(51) Int. Cl. B01D 53/62

(52) U.S. Cl. CPC B01D 53/62
USPC 252/189

(57) ABSTRACT

A solvent for selective absorption of CO₂ from the flue gas from a combustion plant is provided. The solvent includes an aqueous solution of a secondary amine as an active scrubbing substance and an additive which inhibits the formation of nitrosamine, the additive including a primary amine. A process for providing an absorption liquid is also provided.

### CROSS REFERENCE TO RELATED APPLICATIONS

This application is the U.S. National Stage of International Application No. PCT/EP2012/050399 filed Jan. 12, 2012 and claims benefit thereof, the entire content of which is hereby incorporated herein by reference. The International Application claims priority to the European Patent Office application No. 11152688.5 EP filed Jan. 31, 2011, the entire contents of which is hereby incorporated herein by reference.

### FIELD OF INVENTION

A solvent for selective absorption of CO2 from the flue gas from a combustion plant is provided. The solvent includes an aqueous solution of a secondary amine as an active scrubbing substance and an additive which inhibits the formation of nitrosamine, the additive including a primary amine. A process for providing an absorption liquid is also provided.

### BACKGROUND OF INVENTION

In fossil-fired power plants for generation of electrical energy, the combustion of a fossil fuel gives rise to a carbon dioxide-containing flue gas. To avoid or to reduce carbon dioxide emissions, carbon dioxide has to be removed from the flue gases. In general terms, various methods are known for removal of carbon dioxide from a gas mixture. The method of absorption-desorption is commonly used particularly for removal of carbon dioxide from a flue gas after an incineration operation. On the industrial scale, carbon dioxide (CO₂) is scrubbed out of the flue gas with an absorption liquid (CO₂ capture operation).

Standard absorption liquids (solvents) are based on primary, secondary or tertiary amines and exhibit a good selectivity and a high capacity for carbon dioxide CO₂. The main aim in flue gas scrubbing is the reduction in the level of carbon dioxide, which is harmful to the climate. The operation used for this purpose should, however, not cause any further emissions which can damage the environment or humans.

However, a more serious problem arises in the CO₂ capture operation as a result of the combination of the amines from the absorption liquid with the nitrogen oxides (NOₓ) from the flue gas from the combustion plant. Even though the concentration of nitrogen oxides in the flue gas is comparatively low, amines with nitrogen oxides form nitrosamines (N-nitroso compounds) which are carcinogenic to living organisms directly, through degradation products or via side reactions. The nitrosamines formed may have a low vapor pressure, and they can therefore also be discharged into the atmosphere via the cleaned flue gas.

There is a high public awareness of nitrosamines, since they can occur in foods (especially in the event of improper preparation), and the predominant number thereof are considered to be carcinogenic. Therefore, nitrosamines are at the focus of the current discussion about low-carbon dioxide power plants, and are relevant to safety for the operation with amine-based solvents. Minimization of the nitrosamine concentration in the CO₂ capture operation is therefore of great importance for the public acceptance of the technology.

Only the nitrosamines formed from secondary amines are stable for any period. The primary nitrosamines react further to give alkenes and alcohols (Lehrbuch der organischen Chemie [Organic Chemistry]; Beyer and Walter, 1991), which are much less of a concern than the carcinogenic nitrosamines. Tertiary amines can react to give stable nitrosamine compounds only through their decomposition products, secondary amines. The reason why secondary amines are nevertheless preferred over the primary amines in CO₂ capture plants is the lower binding energy and hence a lower loss of efficiency in the overall power plant. Moreover, secondary amines exhibit a much higher loading capacity for CO₂ compared to primary amines. Tertiary amines have the disadvantage that they react very slowly with carbon dioxide and thus require large columns.

In the case of gas scrubbing in the chemical industry, there is no occurrence of the problem since the nitrosating substance (nitrogen dioxide, or nitrogen monoxide which is to be oxidized to nitrogen dioxide) is generally not present, as a result of which there is also no possibility of nitrosation. In some operations, for example the tire industry, inhibitors are deliberately added to the operation in order to prevent the formation of the N-nitroso components. In the food industry, there are some known and effective inhibitors, for example selenium. However, the acidic medium present therein differs distinctly from the alkaline conditions in the CO₂ deposition. In the CO₂ deposition operation, these inhibitors, if they are effective at all under the conditions of a CO₂ capture operation, would have to be initially charged in large amounts in order to compete against the amine present in high concentration in the reaction with the nitrosating reagent. An extreme disadvantage for the CO₂ capture operation is the large burden of inactive substance (inhibitor) in the process circuit, which additionally has to be pumped in circulation and thus lowers the efficiency of the power plant further.

### SUMMARY OF INVENTION

It is an object of the invention to specify a solvent comprising a secondary amine with distinctly reduced formation of nitrosamines on contact with nitrogen dioxide. It is a further object of the invention to specify a process for providing an absorption liquid with reduced formation of nitrosamines. It is a further object of the invention to specify a use of a solvent for selective absorption of CO₂ from the flue gas from a combustion plant. In addition, the disadvantages from the prior art are to be avoided.

The object of the invention directed to a solvent is achieved by a solvent comprising an aqueous solution of a secondary amine and an additive which inhibits the formation of nitrosamine, wherein the additive comprises a primary amine or a primary amino acid salt.

The invention proceeds from the finding that nitrogen dioxide reacts more quickly with a primary amine than with a secondary amine. This preferentially results in the unstable primary nitrosamines which react further to give alkenes and alcohols. The reaction of the nitrogen dioxide with the secondary amines proceeds relatively slowly compared to the primary amines, such that the invention distinctly inhibits the formation of stable secondary nitrosamines. The result of this is that even a small addition of a primary amine to the solvent allows the formation of stable nitrosamine compounds to be reduced to a high degree. The strength of the inhibition depends on the amount of primary amine and the reaction rate thereof with the nitrosating substance which has been added to the solvent through the additive. It has been found to be advantageous to add a primary amine in the additive in the lower percent range, based on the amount of secondary amine.

The great advantage of the primary amine as an additive is that it is actively involved in the absorption and desorption of CO₂ from the flue gas. As a result, in spite of a comparatively high proportion of the primary amine, no increase in pumped circulation of the solvent is required.

The amines used may be alkanolamines, sterically hindered amines, amino acids or amino acid salts. The invention considerably reduces the complexity for special measures involved in handling the nitrosamine-forming solvent. The secondary amine in the solvent is the primary active scrubbing substance in the absorbent. The primary amine also takes an active part in the scrubbing operation, but is classified as secondary due to the higher binding energy and the lower loading capacity.

An advantageous ratio between secondary amine and primary amine has been found to be between 80:20 and 99:1, and more advantageously between 90:10 and 95:5. The ratio is based on percentages by weight. The aim of the addition of the additive is mainly distinct inhibition of the formation of stable nitrosamines. The primary amine in the additive achieves this aim. Nevertheless, there are adverse effects of the primary amine on the solvent comprising the secondary amine. The advantage of higher reactivity of the primary amine over the secondary amine is associated with the disadvantage of higher binding energy. As a result, for the desorption, more energy is required to break the primary amine bonds. The primary amine should therefore be in a very low ratio relative to the secondary amine. In this context, it needs to be considered whether it is more favorable from an economic point of view to put more energy into the desorption of the solvent at a relatively high ratio of primary amine, or to invest more energy into the subsequent destruction of the nitrosamines or into the purification of the solvent at a relatively low ratio of primary amine. Under some circumstances, an addition in the lower range is even energetically advantageous due to the faster reaction rate. This leads to an activation of the entire solvent and leads to an increase in the CO₂ uptake in the absorber.

In an advantageous configuration, the secondary amine is an amino acid salt. In a further advantageous configuration, the primary amine is an amino acid salt. Appropriately, both the primary and the secondary amine would therefore be selected from the group of the amino acid salts. Amino acid salts have the advantage over other amines, such as alkanolamines, sterically hindered amines or amino acids, that they do not have any noticeable vapor pressure. The inventive solvent can be employed particularly advantageously in the case of amino acid salts, since the subsequent purification or the destruction of the stable nitrosamines is much more difficult in the case of amino acid salts than in comparison to conventional amines such as the alkanolamines or sterically hindered amines. In the case of alkanolamines, one option is distillation for the purification. Due to the lack of vapor pressure, in contrast, this is not possible for amino acid salts. These can be separated from the nitrosamines only by crystallization of the salt.

This object directed to a process is achieved by a process for providing an absorption liquid, in which an aqueous solution is made up with a secondary amine, and an additive is introduced into the aqueous solution, the additive comprising a primary amine.

The additive may also include further constituents. It is also possible that different primary amines are present in a mixture.

An advantageous ratio between secondary amine and primary amine has been found to be between 80:20 and 99:1. A more advantageous ratio is between 90:10 and 95:5.

In the case of a particular application of the process, the secondary amine dissolved in the aqueous solution is an amino acid salt. The primary amine dissolved is advantageously an amino acid salt.

The object of the invention directed to a use is achieved by the use of a solvent for selective absorption of CO₂ from the flue gas from a combustion plant, wherein the solvent comprises an aqueous solution of a secondary amine and an additive, said additive comprising at least one primary amine. The combustion plant may be a fossil-fired steam power plant, a gas turbine plant, or a combined gas and steam turbine plant.

In an advantageous development, the additive is replenished in the operation of the CO₂ capture plant to the degree to which it is consumed.

### BRIEF DESCRIPTION OF THE DRAWINGS

Working examples of the invention are illustrated in detail hereinafter with reference to figures. The figures show:

FIG. 1 a diagram showing the rate of formation of nitrosamines over time,

FIG. 2 a structural formula showing the formation and decomposition of a primary amine,

FIG. 3 a structural formula showing the formation of a secondary amine,

FIG. 4 an example of a secondary amine,

FIG. 5 an alternative example of a secondary amine,

FIG. 6 an example of a primary amine,

FIG. 7 an alternative example of a primary amine,

FIG. 8 a further alternative example of a primary amine.

### DETAILED DESCRIPTION OF INVENTION

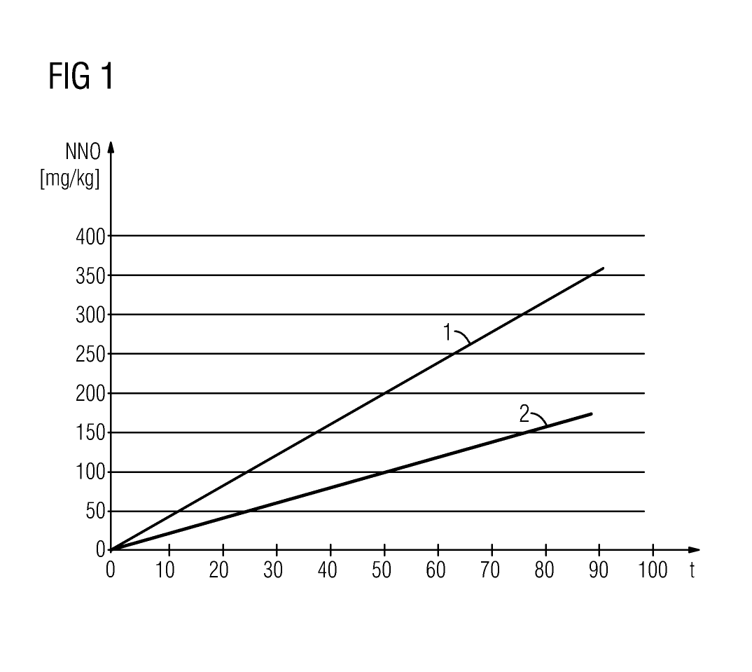

The diagram shown in FIG. 1 shows the rate of formation of stable nitrosamines (NNO) in mg per kg over time. The upper function shows, in schematic form, the rate of formation of a solvent 1 comprising a secondary amine 4 as the active scrubbing substance. There is a clear rise in the nitrosamines 5 over time, i.e. in conjunction with the solvent comprising the CO₂-containing flue gas. The nitrosamine concentration rises up to the equilibrium of the reaction of the stable nitrosamines in the solvent 1 (not evident in the diagram). The lower function shows a solvent 2 comprising the same secondary amine 4 and an additive 6 comprising a primary amine 3. The ratio between secondary amine 4 and primary amine 3 in this working example is 95:5. The functions show that the rate of formation in the case of a solvent comprising an additive 6 comprising a primary amine 3 is much lower compared to a solvent comprising a purely secondary amine 4. With increasing concentration of primary amine 3, the formation of nitrosamines 5 can be inhibited further.

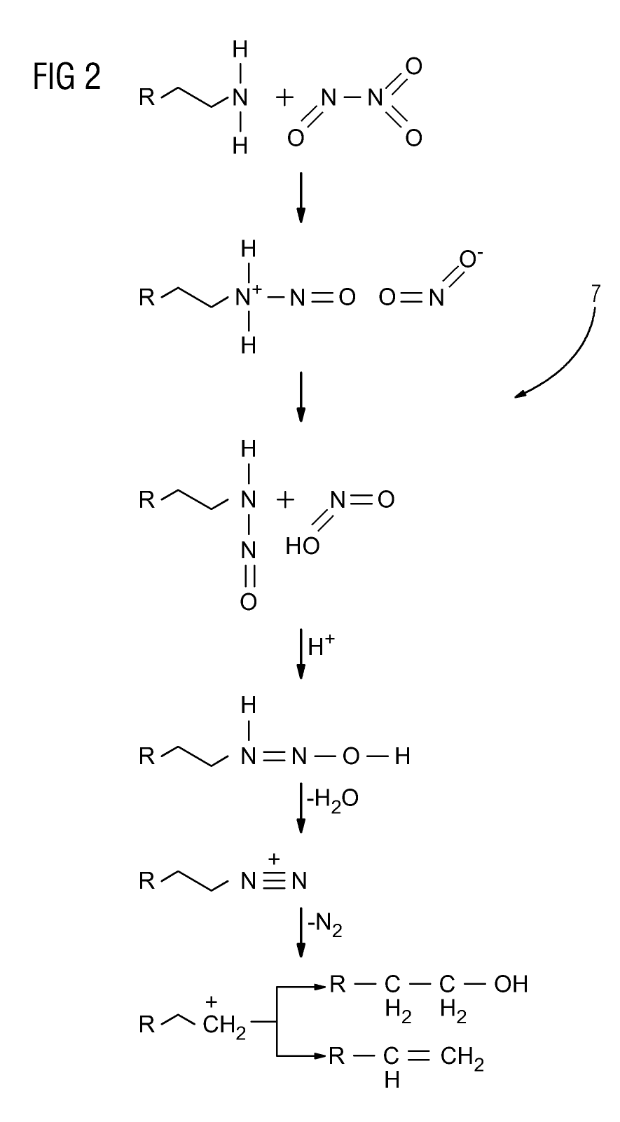

FIG. 2 shows a structural formula showing illustrative formation and the decomposition of an unstable primary nitrosamine compound 7 from a primary amine 3. It can be inferred from the structural formula that a primary amine 3 reacts together with NO₂ to give an unstable nitrosamine compound 7. The unstable nitrosamine compound 7 then decomposes again to form the corresponding alkenes and alcohols, which are much less of a concern from environmental and health aspects.

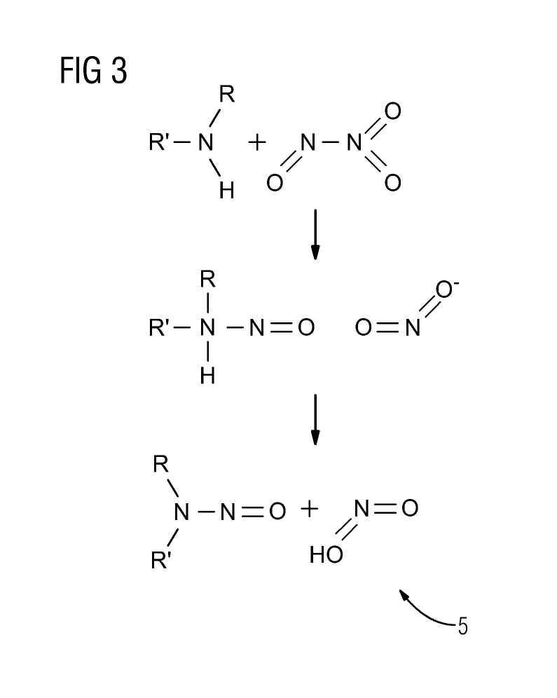

Compared to FIG. 2, FIG. 3 shows a structural formula showing illustrative formation of a stable secondary nitrosamine compound 5. The secondary amine reacts in combination with the NO₂ to give a stable nitrosamine compound 5, which does not react any further in the operation. There is thus no decomposition or degradation of the nitrosamines, as a result of which a high concentration of stable nitrosamine compound 5 accumulates in the solvent over the course of contact with the acidic flue gases (CO₂, NO₂ etc.).

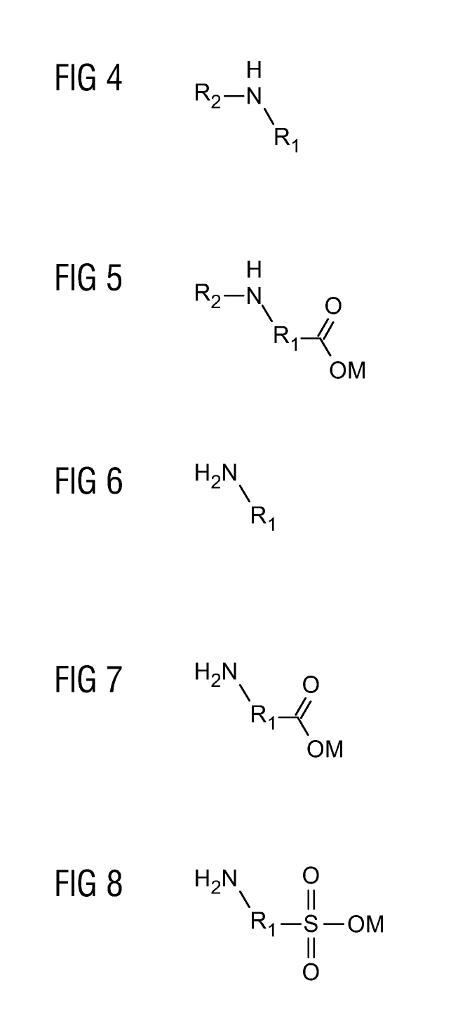

FIG. 4 to FIG. 8 show illustrative primary and secondary amines. FIG. 4 shows a secondary amine where R1 and R2 are each alkyl, aryl, hydroxyalkyl or haloalkyl.

FIG. 5 shows an alternative example of a secondary amine (amino acid salt) where R1 and R2 are each alkyl, aryl, hydroxyalkyl or haloalkyl, and M is Na, K, Li, Mg, Ca or Be.

FIG. 6 shows an example of a primary amine where R1 and R2 are each alkyl, aryl, hydroxyalkyl or haloalkyl. As an alternative to FIG. 5, FIG. 6 shows a primary amine where R1 is alkyl, aryl, hydroxyalkyl or haloalkyl, and M is Na, K, Li, Mg, Ca or Be. A further example of a primary amine (amino acid salt) is shown by FIG. 8 where R1 is alkyl, aryl, hydroxyalkyl or haloalkyl, and M is Na, K, Li, Mg, Ca or Be.

1-7. (canceled)

8. A solvent, comprising:
an aqueous solution of a secondary amino acid salt; and
an additive which inhibits the formation of nitrosamine,
wherein the additive comprises a primary amine, and
wherein the primary amine is an amino acid salt.

9. The solvent as claimed in claim 8, wherein the ratio between secondary amino acid salt and the primary amine is between 80:20 and 99:1.

10. A process for providing an absorption liquid, comprising:
making an aqueous solution with a secondary amino acid salt; and
introducing an additive which inhibits the formation of nitrosamine into the aqueous solution, the additive comprising a primary amino acid salt.

11. The process as claimed in claim 10, wherein the ratio between secondary amino acid salt and the primary amino acid salt is adjusted to between 80:20 and 99:1.

12. An absorption liquid produced according to claim 10.
